(19) United States
(12) Patent Application Publication
(10) Pub. No.: US 2002/0083603 A1
(43) Pub. Date: Jul. 4, 2002

(54) Infrared pointer holder

(76) Inventor: Jong Shuenn Jang, Hwa Lian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/752,429

(22) Filed: Jan. 3, 2001

(51) Int. Cl. G01C 1/00; G01C 15/10

(52) U.S. Cl. 33/281; 33/283; 33/286

(57) ABSTRACT

An infrared pointer holder includes a stand for mounting, the stand having an upright post terminating in a ball socket, a ball rotated in the ball socket, the ball having a protruded connecting rod, lock means adapted to lock the ball in the ball socket of the stand in the desired angle, a holder base fixedly connected to the connecting rod of the ball, the holder base having a revolving shaft extended in direction perpendicular to the connecting rod of the ball, a DC motor controlled to rotate the revolving shaft, and a coupler coupled to the revolving shaft of the holder base and holding an infrared pointer for measuring the direction and distance of a target.

### BACKGROUND OF THE INVENTION

The present invention relates to a holder for holding an infrared pointer and, more particularly, to such an infrared pointer holder that can be adjusted horizontally as well as vertically to the desired angle for measuring the direction and distance of a target Various infrared pointers have been disclosed for use to aim at an object, or to measure the distance of a target. When an infrared pointer is used, it is difficult to accurately held the. infrared pointer in a fixed direction and a fixed elevation. Further, conventional levels for showing whether a surface is level are commonly complicated and heavy. When a level is used, an erroneous measuring result may occur due to human error. Using a level with an infrared pointer improve the accuracy in measuring the direction and distance of a target.

### SUMMARY OF THE INVENTION

The present invention has been accomplished under the circumstances in view. It is one object of the present invention to provide an infrared pointer holder, which enables the infrared pointer to be adjusted horizontally as well as vertically to any desired angle. It is another object of the present invention to provide an infrared pointer holder, which enables the infrared pointer to be adjusted horizontally as well as vertically for measuring the direction and distance of a target. According to one aspect of the present invention, the infrared pointer holder comprises a stand, a ball coupled to a ball socket at the stand, a holder base fixedly fastened to a fixed connecting rod at the periphery of the ball, the holder base holding a motor and a revolving shaft rotated by the motor, and a coupler coupled to the revolving shaft and holding an infrared pointer. According to another aspect of the present invention, levels are respectively fastened to different sidewalls of the holder base for showing whether the respective sidewall is level. According to still another aspect of the present invention, the coupler comprises a graduated disk adapted to match with the infrared pointer for measuring the direction and distance of a target.

### BRIEF DESCRIPTION OF THE DRAWINGS

FIG. 1 is an exploded view of an infrared pointer holder according to the present invention.

FIG. 2 is an elevational view of the present invention, showing an infrared pointer fastened to the infrared pointer coupler, the infrared pointer coupler rotated with the shaft, the connecting rod turned to horizontal.

FIG. 3 is another elevational view of the present invention, showing the infrared pointer coupler rotated with the shaft, the connecting rod turned to vertical.

FIG. 4 is an exploded view, partially in section, of a part of the present invention, showing the internal arrangement of the holder base.

FIG. 5 is a schematic drawing showing an application of the present invention.

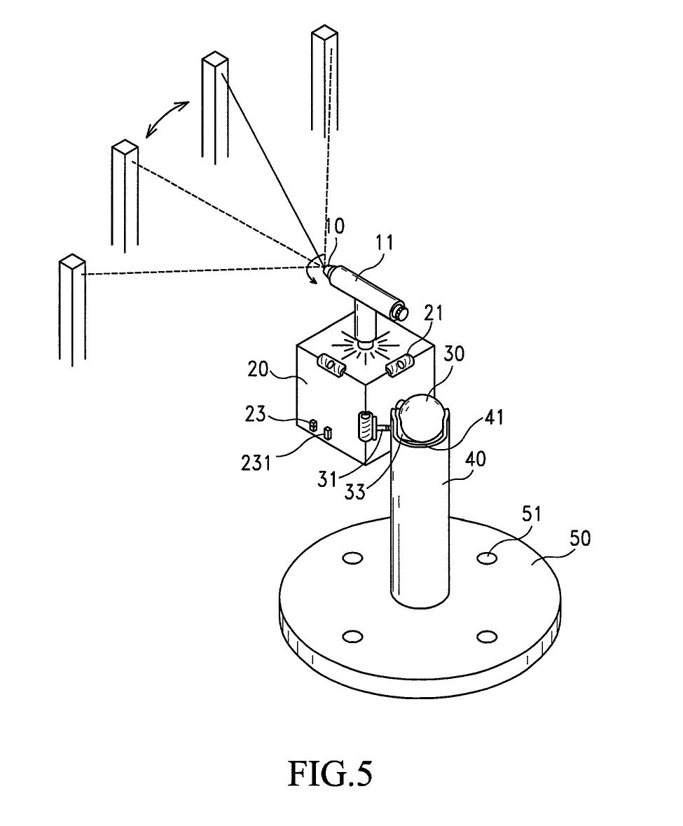

FIG. 6 is an elevational view of an alternate form of the present invention.

### DETAILED DESCRIPTION OF THE PREFERRED EMBODIMENT

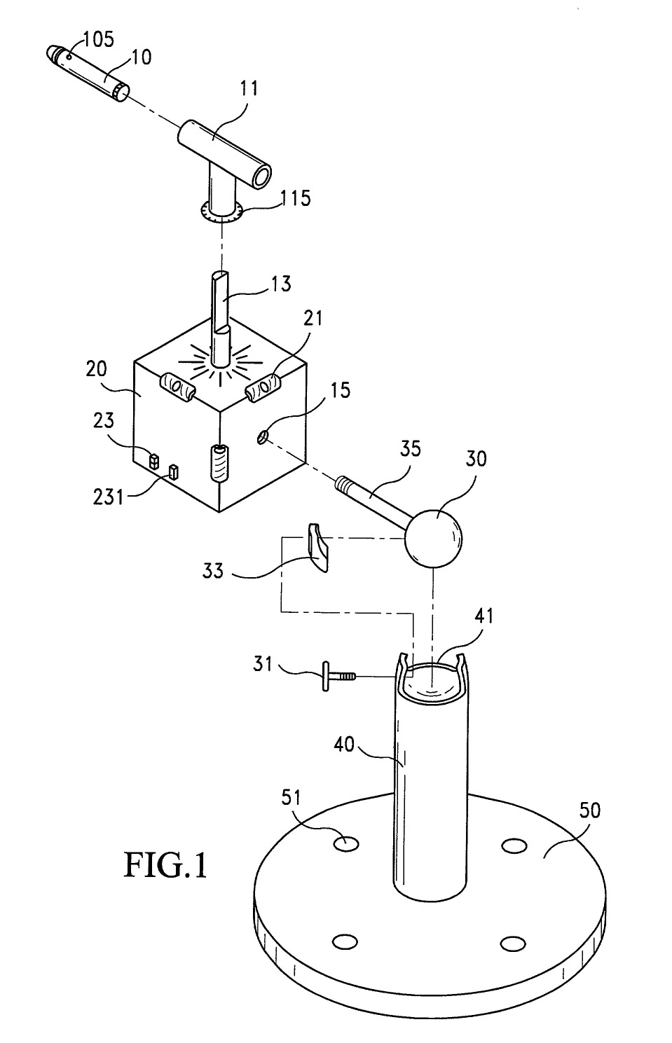

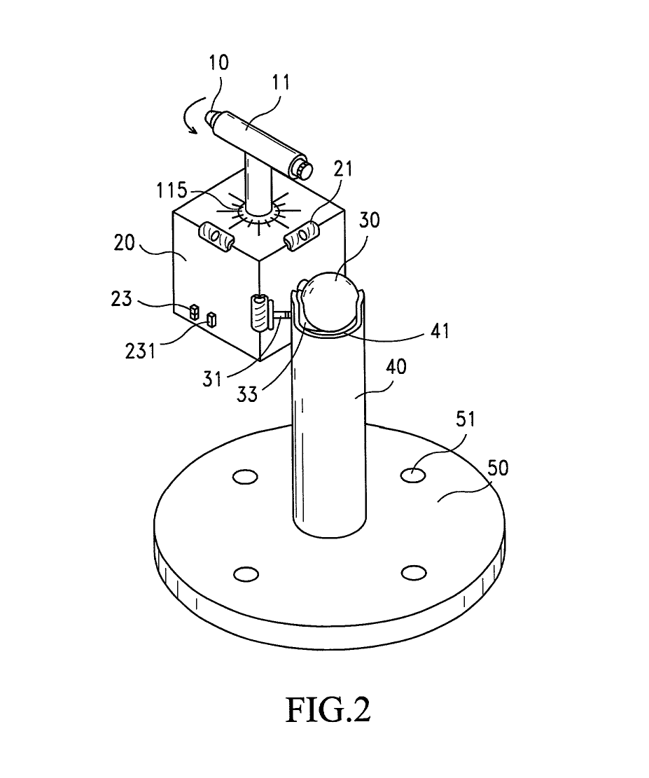

Referring to FIGS. 1 and 2, an infrared pointer holder is shown comprised of a holder base 20, infrared pointer coupler 11, a ball 30, and a stand 50. The stand 50 is a magnetic device that can be secured to a metal object by magnetic attraction, comprising a plurality of screw holes 51 for mounting, and an upright post 40 at the center. The upright post 40 has a ball socket 41 at its top end. The ball 30 is received in the ball socket 41, having a connecting rod 35 extended from the periphery. A smoothly arched friction pad 33 is mounted in the ball socket 41 at one side and disposed in contact with the periphery of the ball 30. A tightening up screw 31 is mounted in the top end of the upright post 40 and fastened to the friction pad 33. When tightening up the tightening up screw 31 to press the friction pad 33 against the ball 30, the ball 30 is positively secured to the ball socket 41 in position. On the contrary, when loosening the tightening up screw 31, the ball 30 is released from the friction pad 33, and can be rotated in the ball socket 41. The holder base 20 is a hollow cubic member comprising a mounting hole 15 disposed at one of the six sidewalls (the first sidewall) and connected to the connecting rod 35 of the ball 30, a shaft 13 extended out of one of the six sidewalls (the second sidewall adjacent to the first sidewall), a plurality of air levels 21 respectively fastened to the sidewalls for showing whether the respective sidewall is level, an on/off switch 23 and a motor speed control 231 disposed at one of the six sidewalls. The function of the switch and the speed control 231 will be described further. The infrared pointer coupler 11 is coupled to the shaft 13 and adapted to hold the infrared pointer 10, having a graduated disk 115 disposed in contact with the holder base 20. The infrared pointer 10 has an on/off switch for operation control. When loosening the tightening up screw 31, the holder base 20 can be turned with the ball 30 relative to the stand 50 to the desired angle. By means of the levels 21, the holder base 20 can be conveniently adjusted to a horizontal position. When adjusted, the on/off switch 23 is switched on to rotate the shaft 13 (this will be described further), enabling the angle of the infrared pointer 10 to be adjusted horizontally.

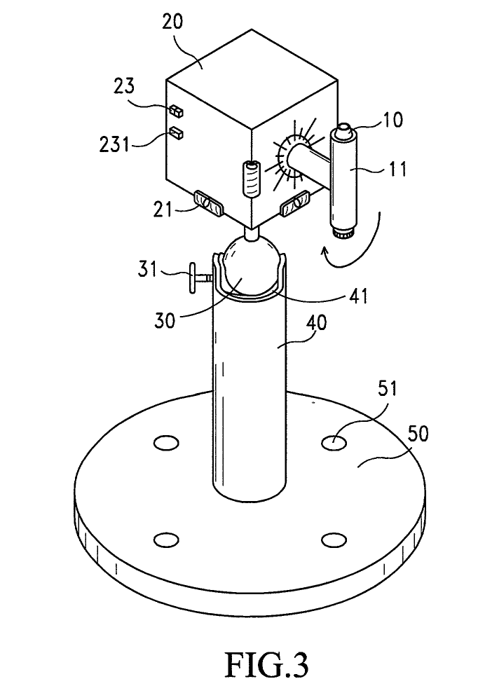

Referring to FIG. 3, the holder base 20 can be turned to the top side in vertical alignment with the connecting rod 35 and the upright post 40 of the stand 50, keeping the shaft 13 in horizontal. In this case, the shaft 13 can be rotated to adjust the angle of the infrared pointer 10 vertically.

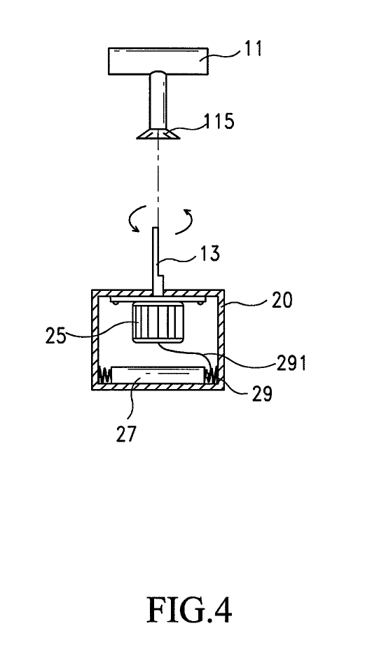

Referring to FIG. 4, a motor 25 is installed in the holder base 20 and controlled by the on/off switch 23 to rotate the shaft 13, two metal springs 20 are installed in the holder base 20 and respectively connected to positive and negative poles of the power input of the motor 35 by conductors 291, and a battery 27 is installed in the holder base 20 and connected between two metal springs 29 to provide the necessary working voltage to the motor 25. The aforesaid motor speed control 231 controls the revolving speed of the motor 25.

When in use, the stand 50 can be placed on a flat surface, secured to a metal object, or fixedly fastened to the platform of a tripod by screws. After the infrared pointer 10 had been fastened to the infrared pointer coupler 11, the on/off switch 105 is switched on, causing the infrared pointer 10 to emit an infrared light beam. By means of the indication of the graduations on the graduated disk 115, the infrared pointer coupler 11 can be rotated with the shaft 13 to the desired angle for enabling the infrared pointer 10 to measure the direction and distance of a target.

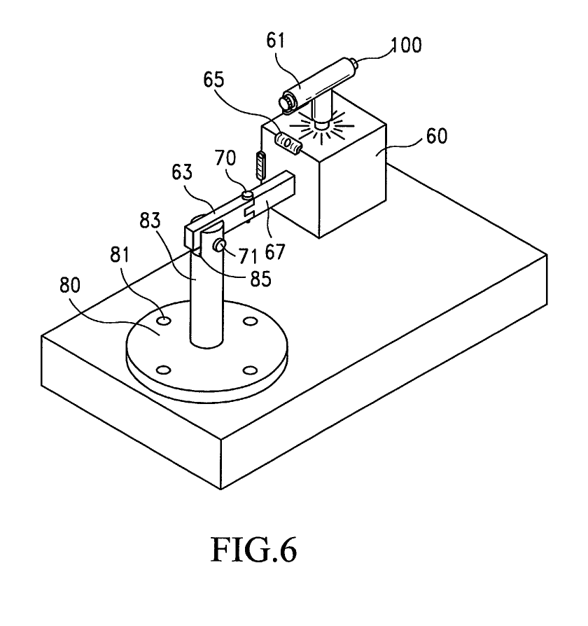

FIG. 6 shows an alternate form of the present invention. According to this alternate form, the infrared pointer holder comprises a stand 80, a holder base 60, a coupling structure connected between the stand 80 and the holder base 60, an infrared pointer coupler 61 coupled to the shaft (not shown) at the holder base 60 to hold an infrared pointer 100. The holder base 60 is equipped with levels 65. The stand 80 comprises a plurality of screw holes 81 for mounting, and an upright post 83. The upright post 83 has a forked top end 85. The coupling structure comprises a first connecting rod 63 vertically pivotally connected to the forked top end 85 of the upright post 83 and locked by a lock screw bolt 71, a second connecting rod 67 fixedly fastened to the holder base 60 and horizontally pivotally connected to the first connecting rod 63 and locked by a lock screw bolt 70.

It is to be understood that the drawings are designed for purposes of illustration only, and are not intended for use as a definition of the limits and scope of the invention disclosed.

What the invention claimed is:

1. An infrared pointer holder comprising:
a sand, said stand comprising a plurality of mounting holes for mounting, and an upright post, said upright post comprising a ball socket at a to side thereof;
a ball rotatably coupled to the ball socket of said upright post of said stand, said ball comprising a connecting rod extended from the periphery thereof;
lock means adapted to lock said ball in the ball socket of said upright post of said stand in position;
a holder base fixedly connected to the connecting rod of said ball, said holder base comprising a revolving shaft extended in direction perpendicular to the connecting rod of said ball; and
a coupler coupled to said revolving shaft of said holder base and holding an infrared pointer for measuring the direction and distance of a target.

2. The infrared pointer holder of claim 1, wherein said holder base further comprises on the inside a motor controlled to rotate said revolving shaft, and battery power supply means connected to said motor to provide the necessary working voltage.

3. The infrared pointer holder of claim 2, wherein said holder base further comprises an on/off switch adapted to control the operation of said motor.

4. The infrared pointer holder of claim 3, wherein said holder base further comprises a speed control adapted to control the revolving speed of said motor.

5. The infrared pointer holder of claim 1, wherein said coupler comprises a graduated disk adapted to match with said infrared pointer for measuring the direction of a target.

6. The infrared pointer holder of claim 1, wherein said holder base comprises a plurality of air levels respectively disposed at peripheral sidewalls thereof for showing whether the respective sidewall is level.

7. The infrared pointer holder of claim 1, wherein said stand comprises a plurality of screw holes for mounting.

8. The infrared pointer holder of claim 1, wherein said stand comprises magnetic means for securing to a metal object by magnetic attraction.

9. The infrared pointer holder of claim 1, wherein said lock means comprises a friction pad mounted in th e ball socket of said upright post of said stand at one side and disposed in contact with said ball, and a tightening up screw mounted in said upright post of said stand and fastened up to force said friction pad against the periphery of said ball and to lock said ball in position.

10. An infrared pointer holder comprising:
a stand, said stand comprising a plurality of screw holes for mounting, and an upright post, said upright post comprising a forked top end;
a holder base, said holder base comprising a revolving shaft;
a coupler coupled to said revolving shaft and holding an infrared pointer; and
a coupling structure coupled between said holder base and said upright post, said coupling structure comprising a first connecting rod vertically pivotally connected to the forked top end of said upright post and locked by a lock screw bolt, a second connecting rod fixedly fastened to said holder base in direction perpendicular to said revolving shaft and horizontally pivotally connected to said first connecting rod and locked by a lock screw bolt.

11. The infrared pointer holder of claim 10, wherein said coupler comprises on the inside a motor controlled to rotate said revolving shaft, and battery power supply means connected to said motor to provide the necessary working voltage.

12. The infrared pointer holder of claim 10, wherein said coupler comprises a graduated disk disposed in contact with said holder base and adapted to match with said infrared pointer for measuring the direction of a target.

13. The infrared pointer holder of claim 10, wherein said holder base comprises a plurality of air levels respectively disposed at peripheral sidewalls thereof for showing whether the respective sidewall is level.

14. The infrared pointer holder of claim 1, wherein said stand comprises magnetic means adapted for securing to a metal object by magnetic attraction.
